(19) United States
(12) Patent Application Publication
(10) Pub. No.: US 2022/0066600 A1
(43) Pub. Date: Mar. 3, 2022

(54) METHODS AND SYSTEMS FOR NAVIGATING A COMPUTER INTERFACE USING A GRID STRUCTURE

(71) Applicant: Avaya Management L.P., Santa Clara, CA (US)

(72) Inventors: Adrian Walsh, Galway (IE); Warren Reilly, Galway (IE); Donal Tarpey, Galway (IE); Brian Cunningham, Galway (IE); Robert Fahy, Galway (IE)

(21) Appl. No.: 17/006,651

(22) Filed: Aug. 28, 2020

(51) Int. Cl. G06F 3/0482; G06F 3/0483; G06F 3/0489; G06F 3/0484; G06F 16/954; G06F 16/958; G06F 16/951

(52) U.S. Cl. CPC G06F 3/0482; G06F 3/0483; G06F 3/0489; G06F 16/168; G06F 16/954; G06F 16/986; G06F 16/951; G06F 3/04845

(57) ABSTRACT

The present disclosure provides, among other things, methods and systems of navigating information that include: detecting, at an electronic device, a first input; displaying, in response to the first input, a first number of cells in a first grid; receiving, as a second input at the electronic device, a first selection of a first cell in the first number of cells in the first grid, where the first cell includes a first piece of information; and displaying, in response to the receiving the first selection, a second number of cells in a second grid, where cells in the second number of cells correspond to a sub-type of information related to the first piece of information.

### FIELD

Embodiments of the present disclosure relate generally to computing systems and specifically to user interfaces for computing systems.

### BACKGROUND

Users navigate and access information on computing devices through various modalities. For example, in computing, a user can navigate a directory by selecting icons or folders that contain references to other folders, files, and pieces of software, or application programs. Users can also navigate through computerized content by selecting items within menus, navigating within expandable lists, and selecting icons or objects (including folders and application programs) to access desired information. Navigation may be accomplished using visual or audio indicators of where desired information is located. Such navigation is often, but not always, done via graphical user interfaces. Many graphical user interfaces convey at least some of the information to users via non-text images, which may be selected or activated through the use of a point-and-click device, such as a mouse or trackball. Oftentimes, users interact with computerized content through graphical user interfaces that are windows-based. A “window” is an area of the display set aside for a specific purpose.

### BRIEF SUMMARY

In order to interact with computerized content, users must often navigate through multiple levels of information. These multiple levels of information exists in a majority of computerized content, including application programs, and other computerized information. Examples include: multiple levels of a directory containing different types of lower-level information (e.g., information contained within other information, contained within other information, etc.), multiple levels of hierarchical information organized in a tree-structure, multiple sections of a document organized into different sections and sub-sections of content, multiple menus and sub-menus (or content and sub-content) of an application program, etc. Even components of system software are organized using levels and sub-levels of information.

Users navigate through computerized information by keeping a mental map of where information is located; however, they must often navigate through multiple levels of information and sub-information in order to reach the desired location. A subset of users, sometimes referred to as “power users,” make intensive use of the computerized content and will take advantage of creating shortcuts in user interfaces in order to reach desired information (or execute desired functionality) faster and more efficiently. These power users oftentimes desire improved user interfaces to assist them with efficiencies in navigating computerized content.

Some users find it cumbersome and time consuming to navigate computerized content. This can be problematic not only for so-called “power users” but also for others users, including users whose physical abilities may not allow them to navigate the content in an efficient manner. For example, using a mouse can be difficult for users who do not have the physical functionality required to scroll through information and click to select information. Also, opening and interacting with different windows to navigate content can be difficult for users who have trouble using a mouse or trouble seeing the content. Such physical disabilities can make it additionally time consuming and cumbersome for users to navigate through various content. Other problems resulting from differences in physical abilities can occur for users when they have to access content where the user interfaces and/or input devices don't work well with the user's particular physical ability, or lack thereof.

For these reasons and others, many users desire improved user interfaces for navigating computerized content. Cost savings result from improved user interfaces that allow users to navigate and access computerized content in a faster and more efficient manner. The cost savings can be even larger if the improved user interface allows users to navigate and access content that is a large amount of information because users are able to navigate the large amount of information in less time. For example, users may use less of their time to physically navigate to a desired content and users may also take less time to think through navigating to the desired content. Cost savings thereby occur because users save time and effort when navigating the content. Therefore, improvements to methods and systems of navigating information are desired because such improvements can reduce costs and improve inefficiencies.

In addition to the above concerns, disability access is increasingly becoming an important issue to software and hardware manufacturers. Oftentimes companies must comply with laws requiring products to have specific features that permit the products to be used by people with disabilities. For example, companies may be required to allow people who unable to see to perform operations, e.g., via a computer keyboard—i.e., without a point-and-click device. This is because people who are blind are unable to discern the position of the on-screen pointer, the locations of targets within windows, and the relative positions and borders of the different windows, icons, etc.

In order to operate graphical user interfaces, people who are blind rely on sophisticated text-to-speech assistive software applications, such as Microsoft Narrator™, JAWS™ by Freedom Scientific BLV Group, LLC, and Window-Eyes™ by GW Micro. Navigation within and between windows is accomplished by using the TAB, ALT, and arrow keys, either singly or in combination with other keys. For example, all non-text elements typically have an underlying text tag, which permits the text-to-speech software to respond appropriately when the TAB function takes the focus to an icon or other graphical image. Thus, pressing TAB within a window causes the programmatic focus to move to the next tab-stop or point-and-click target. With each press of the TAB key, the text-to-speech software provides a spoken description of the target. When the desired target is voiced-out, the user may execute the function by pressing the ENTER key.

A similar mechanism allows users to move among different applications, and to select the window to be activated. This is accomplished by pressing the ALT key continuously while pressing and releasing the TAB key. With each press of the TAB key, users may move sequentially through the windows that have been opened. The sequence of movement is in chronological order, starting with the window that had been activated most recently. Power users, many without physical disabilities, sometimes use this method of navigating content in order to navigate through open windows with greater speed. For users navigating content with voice assistive technology, immediately after each release of the TAB key (but not the ALT key), the assistive text-to-speech software reads the title bar of the selected window. When the user hears the software speak the title of the desired window, the user causes that window to be activated by releasing the ALT key. Other methods for users with disabilities to interact with computerized information include voice recognition, one-handed typing, and specialized keyboards. Such processes can be frustratingly time-consuming for users.

Although support for keyboard-based control does permit graphical user interfaces to be operated by people who are visually impaired, this style of operation is often considerably slower and more tedious than what is available to people who are able to operate point-and-click devices. This is because, for example, visually impaired users are unable to discern the position of the on-screen pointer, the locations of targets within windows, and the relative positions and borders of the different windows that may be open, and they must listen through various options in order to select a desired destination or action. In this context, it is important to note that sighted users often form a mental map of where desirable point-and-click targets are located, thereby permitting them to move the pointer to the target very quickly. Blind users would benefit from improved user interfaces that enable them to take advantage of memorable location-specific data in the information presented to them.

Embodiments of the present disclosure aim to improve user navigation of computer content. In various embodiments, alternative methods of interacting with a user interface are provided. In some embodiments, the alternative methods assist users who cannot use a mouse or need a backup interface. In other embodiments, the alternative methods assist power users of systems because the power users often prefer to use keyboard shortcuts to interact with content.

Various aspects of the disclosure are directed to keyboard-only navigation of content. For example, a user may be presented with a user interface that he wants to navigate via a keyboard. The user's left hand can press a specific key combination (e.g., pressing four keys on the keyboard simultaneously) to activate a grid display on the user interface. While holding down the multiple keys with his left hand, the user may select a cell of the grid that he wants to focus on first by either using the direction keys or entering a number using his right hand (e.g., number 3 corresponds to the top right cell in the grid). After a new cell is selected, another grid is displayed within the user interface. Again, with the newly displayed grid, the user can select a cell using keyboard inputs, and this can be repeated until the desired content is within the cell. In various embodiments, once the user is satisfied that he has navigated to the correct cell, he can trigger a selection of the cell. The user may select the cell by either pressing another key or by releasing all of the keys held by the left hand. In various embodiments, users may perform actions on the information that is accessed through the improved user interfaces disclosed herein, such as editing (e.g, creating, configuring, updating, and deleting) the information.

Embodiments disclosed herein can be used to navigate various types of information and content, including any type of directory information, documents, application programs, etc. Various examples of content that a user can navigate using the user interfaces disclosed herein include and are not limited to: business application software including document processing software and document content; enterprise software including customer relationship management (“CRM”) systems, resource planning systems, and supply chain management software; infrastructure software including databases, email servers, and network and security management software; content access programs including web browsers and media players; educational software; and media development software including Hypertext Markup Language (“HTML”) editors, audio content editors, and video content editors.

A specific example of an application program that may be navigated via the user interfaces as disclosed herein is a programming interface for HTML and Extensible Markup Language (“XML”) documents, referred to as a Document Object Model (“DOM”). The DOM is the data representation of objects that includes the structure and content of a document on the web and the content of the DOM is structured as a hierarchical tree. The DOM represents the document as nodes and objects. Programming languages are then able to connect to the page via the nodes and objects. In various embodiments, the DOM can be navigated using a succession of ever-refined grids as described herein.

Aspects of the present disclosure provide for systems and methods to provide grid scanning capabilities via user interfaces by using grids to navigate through a keyboard. For example, users may easily scroll through content presented in a grid format by navigating up and down the rows within the grid and across columns of the grid. Such methods of navigation allows users to quickly and efficiently navigate the information within the grid.

These and other needs are addressed by the various embodiments and configurations of the present disclosure. The present disclosure can provide a number of advantages depending on the particular configuration. These and other advantages will be apparent from the disclosure contained herein.

According to some aspects of the present disclosure, methods of navigating information include: detecting, at an electronic device, a first input; displaying, in response to the first input, a first number of cells in a first grid; receiving, as a second input at the electronic device, a first selection of a first cell in the first number of cells in the first grid, where the first cell includes a first piece of information; and displaying, in response to the receiving the first selection, a second number of cells in a second grid, where cells in the second number of cells correspond to a sub-type of information related to the first piece of information.

According to some aspects of the present disclosure, methods of navigating information, the method including: detecting, at an electronic device, a first input; displaying, in response to the first input, a first number of cells in a first grid; receiving, as a second input at the electronic device, a first selection of a first cell in the first number of cells in the first grid, where the first cell includes a first piece of information; and displaying, in response to the receiving the first selection, a second number of cells in a second grid, where each of the cells in the second number of cells each correspond corresponds to a sub-type of information related to the first piece of information.

Another aspect of the disclosure is that the methods further include: receiving, as a third input at the electronic device, a second selection of a second cell in the second number of cells, where the second cell includes a second piece of information; and in response to the receiving the second selection, displaying a third number of cells in a third grid, where cells in the third number of cells each correspond to a sub-type of information related to the second piece of information.

Another aspect of the disclosure is that the methods further include: receiving, as a third input at the electronic device, a second selection of a second cell of the first number of cells in the first grid, where the second cell includes a different piece of information; and in response to the receiving the second selection, displaying a third number of cells in a third grid, where cells in the third number of cells each correspond to a sub-type of information related to the different piece of information.

Another aspect of the disclosure is that the methods further include: a set of grids including the first grid and the second grid; receiving, as a third input at the electronic device, at least one additional selection of a second cell in one grid in the set of grids; and in response to the receiving each additional selection, displaying a corresponding number of cells in a corresponding grid; where cells in the corresponding number of cells in each of the corresponding grids are each determined based on a number of nodes in a level of a tree structure of elements, and where information in at least some of the corresponding number of cells in each of the corresponding grids corresponds to nodes in the tree structure of elements.

In some embodiments, different combinations of keys on a keyboard are associated with different sets of information associated with cells in the first number of cells in the first grid, and where the first input includes pressing one of the different combinations of keys.

Another aspect of the disclosure is that the methods further include: receiving, as a third input at the electronic device, a second selection of a second cell in the second number of cells, where the second cell includes a second piece of information; and in response to the receiving the second selection, displaying a third number of cells in a third grid, where cells in the third number of cells correspond to a sub-type of information related to the second piece of information.

Another aspect of the disclosure is that the methods further include: receiving, as a third input at the electronic device, a second selection of a second cell of the first number of cells in the first grid, where the second cell includes a different piece of information; and in response to the receiving the second selection, displaying a third number of cells in a third grid, where cells in the third number of cells correspond to a sub-type of information related to the different piece of information.

In some embodiments, a set of grids include the first grid and the second grid; the methods further include: receiving, as a third input at the electronic device, at least one additional selection of a second cell in one grid in the set of grids; and in response to the receiving each additional selection, displaying a corresponding number of cells in a corresponding grid; where each of the corresponding number of cells in each of the corresponding grids is determined based on a number of nodes in a level of a tree structure of elements, and where information in at least some of the corresponding number of cells in each of the corresponding grids represents nodes in the tree structure of elements.

In some embodiments, the first number of cells is a preset number of cells. In some embodiments, the first number of cells is determined based on a number of nodes in a level of a tree structure of elements.

In some embodiments, the tree structure of elements is a web page Document Object Model (“DOM”).

In some embodiments, the first input includes pressing a specified combination of keys on a keyboard. In some embodiments, the second input includes pressing or releasing a first key. In some embodiments, pressing or releasing a subsequent key navigates to one of the second number of cells in the second grid. In some embodiments, different combinations of keys on a keyboard are associated with different sets of information associated with each of the first number of cells in the first grid, and the first input includes pressing one of the different combinations of keys.

In some embodiments, the first grid occupies a first area of a display screen, and the second grid occupies an entirety of the first area. In some embodiments, the first grid is a layout of 3×3 cells.

In some embodiments, the first grid and the second grid are navigated by one of a keyboard and a mouse, and when the one of the keyboard and the mouse stop working then another one of the keyboard and the mouse navigates the first grid and the second grid.

According to some aspects of the present disclosure, systems of navigating information include: a processor; and computer memory storing data thereon that enables the processor to: detect, at an electronic device, a first input; display, in response to the first input, a first number of cells in a first grid; receive, as a second input at the electronic device, a first selection of a first cell in the first number of cells in the first grid, where the first cell includes a first piece of information; and display, in response to the receiving the first selection, a second number of cells in a second grid, where each of the cells in the second number of cells corresponds to a sub-type of information related to the first piece of information.

According to some aspects of the present disclosure, systems of navigating information, including: a processor; and computer memory storing data thereon that enables the processor to: detect, at an electronic device, a first input; display, in response to the first input, a first number of cells in a first grid; receive, as a second input at the electronic device, a first selection of a first cell in the first number of cells in the first grid, where the first cell includes a first piece of information; and display, in response to the receiving the first selection, a second number of cells in a second grid, where each of the cells in the second number of cells each correspond corresponds to a sub-type of information related to the first piece of information.

In some embodiments, the first grid corresponds to a first level of nodes in a tree structure, and where the second grid corresponds to a second level of nodes in a tree structure that is a sub-level of one of the nodes in the first level.

In some embodiments, the first number of cells is a preset number of cells, and the preset number of cells is determined based on a number of nodes in a level of a tree structure of elements.

In some embodiments, the first input includes pressing a specified combination of keys on a keyboard.

In some embodiments, different combinations of keys on a keyboard are associated with different sets of information associated with cells in each of the first number of cells in the first grid, and where the first input includes pressing one of the different combinations of keys. In some embodiments, the first grid corresponds to a first level of nodes in a tree structure, and the second grid corresponds to a second level of nodes in a tree structure that is a sub-level of one of the nodes in the first level. In some embodiments, the first number of cells is a preset number of cells, and the preset number of cells is determined based on a number of nodes in a level of a tree structure of elements.

In some embodiments, the first input includes pressing a specified combination of keys on a keyboard. In some embodiments, different combinations of keys on a keyboard are associated with different sets of information associated with each of the first number of cells in the first grid, and where the first input includes pressing one of the different combinations of keys.

According to some aspects of the present disclosure, systems include: a microprocessor and a computer-readable medium coupled thereto, where the microprocessor receives and executes instructions from the computer-readable medium and where the instructions cause the microprocessor to: detect, at an electronic device, a first input; display, in response to the first input, a first number of cells in a first grid; receive, as a second input at the electronic device, a first selection of a first cell in the first number of cells in the first grid, where the first cell includes a first piece of information; and display, in response to the receiving the first selection, a second number of cells in a second grid, where cells in the second number of cells correspond to a sub-type of information related to the first piece of information.

As used herein, the term “information” includes and is not limited to data, applications, software programs, and content thereof. Information may be referred to herein as “data” and “content.” Information may be any type of data that is accessible by electronic means. Information includes records, text, rich media, and/or data structures. Information may be data that is stored on a storage/memory device, and/or transmitted via a communication network. Thus, information may be various types of data. Information may be organized in any manner, such as a nonlinear or a linear data structure. In various embodiments, information may be organized in a hierarchical structure having multiple levels, including as a tree structure. Although the present disclosure may refer to cells or grids “containing” information, it is to be understood that the cells and grids may alternatively contain references to, or indicators of, associated information. A user may then view an entirety of the associated information in any manner, such as by hovering over a cell (if using a mouse) or by otherwise selecting to view the content of a cell.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “analyze,” “process,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively or additionally, methods described or claimed herein can be performed using AI, machine learning, neural networks, or the like. In other words, a system or contact center is contemplated to include finite instruction sets and/or artificial intelligence-based models/neural networks to perform some or all of the steps described herein.

### BRIEF DESCRIPTION OF THE DRAWINGS

FIG. 1 is a block diagram illustrating a first system of an electronic device in accordance with at least some embodiments of the present disclosure;

FIG. 2 is a diagram illustrating grids in accordance with at least some embodiments of the present disclosure;

FIG. 3A is a HTML document in accordance with at least some embodiments of the present disclosure;

FIG. 3B is a DOM in accordance with at least some embodiments of the present disclosure;

FIG. 4A is a screenshot depicting a first set of information in accordance with at least some embodiments of the present disclosure;

FIG. 4B is a screenshot depicting a second set of information in accordance with at least some embodiments of the present disclosure;

FIG. 4C is a screenshot depicting a third set of information in accordance with at least some embodiments of the present disclosure;

FIG. 4D is a screenshot depicting a fourth set of information in accordance with at least some embodiments of the present disclosure; and

FIG. 5 is a flow diagram depicting a method in accordance with at least some embodiments of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides illustrative embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the illustrative embodiments will provide those skilled in the art with an enabling description for implementing an illustrative embodiment. It should however be appreciated that the present disclosure may be practiced in a variety of ways beyond the specific detail set forth herein.

While the illustrative aspects, embodiments, and/or configurations illustrated herein show the various components of the system collocated, certain components of the system can be located remotely, at distant portions of a distributed network, such as a Local Area Network (LAN) and/or the Internet, or within a dedicated system. Thus, it should be appreciated, that the components of the system can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

Embodiments of the disclosure provide systems and methods for providing a user interface to access information. The information may be presented in a grid format where cells are presented in a grid. A user may navigate cells within the grid and select a cell to obtain related information, which may also be presented in a grid format.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

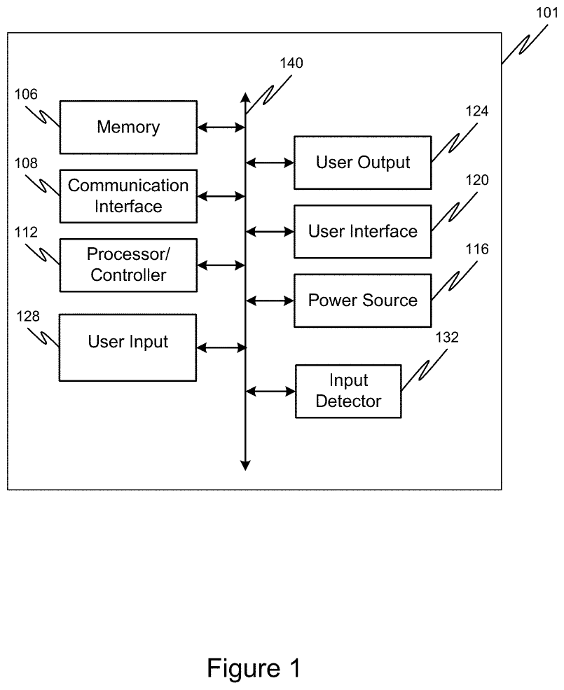

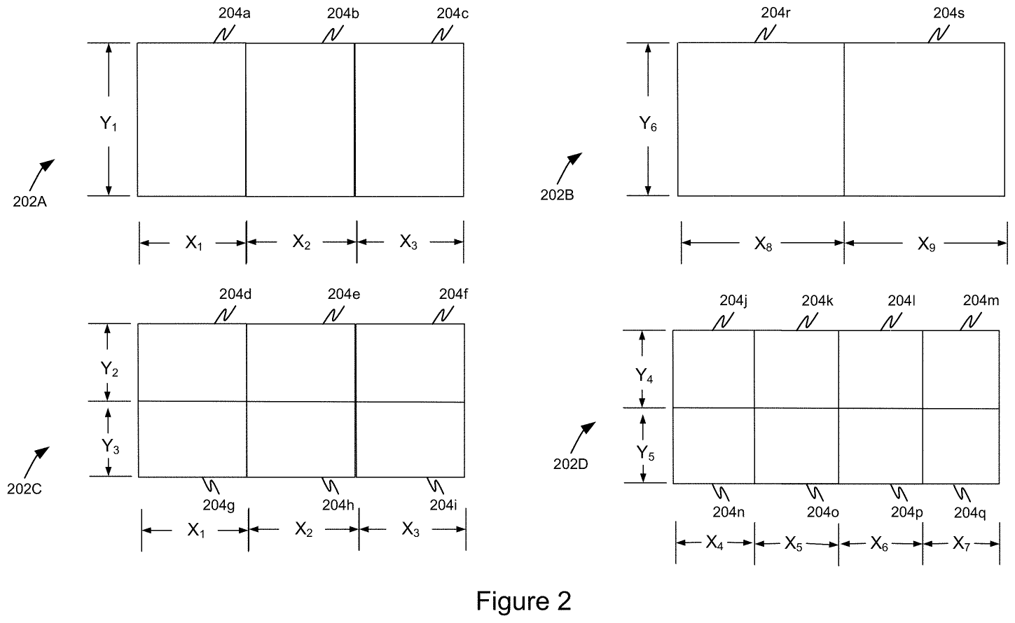

FIG. 1 is a block diagram illustrating a first system of an electronic device 101 in accordance with at least some embodiments of the present disclosure. Electronic device 101 includes one or more devices and/or device types, such as a server, computer, or other communication component. In various embodiments, electronic device 101 may be a telephone, computer, laptop, a handheld device (such as a personal data assistant), a cellular telephone/smart-phone, a tablet, etc. Electronic device 101 may be any application-executing device, such as a device that executes a softphone, messaging system, video/voice-over-IP, etc. As described herein, electronic device 101 can display a user interface having one or more elements that can be selected by a user (e.g., by hovering over the element and clicking a mouse button or touching a location of the element on a touch sensitive display). These selectable elements can include, for example, icons corresponding to apps, hyperlinks, items in a menu bar, a section of a display, and the like. To illustrate, FIG. 2 shows illustrative user interfaces 202A-202D having selectable elements (e.g., cells 204a-204s). Each selectable cell 204a-204s can be selected (e.g., by touching a location of the element on a touch sensitive display or by selecting the cell using keys on a keyboard) by a user.

In some embodiments, the electronic device 101 may include a processor/controller 112 capable of executing program instructions. The processor/controller 112 may include any general purpose programmable processor or controller for executing application programming. The processor/controller 112 generally functions to execute programming code that implements various functions performed by the associated server or device.

The electronic device 101 may additionally include memory 106. The memory 106 may be used in connection with the execution of programming instructions by the processor/controller 112, and for the temporary or long term storage of data and/or program instructions. For example, the processor/controller 112, in conjunction with the memory 106 of the electronic device 101, may implement user interfaces used by or accessed by one or more users of the electronic device 101.

The memory 106 of the electronic device 101 may include solid-state memory that is resident, removable and/or remote in nature, such as DRAM and SDRAM. Moreover, the memory 106 may include a plurality of discrete components of different types and/or a plurality of logical partitions. In accordance with still other embodiments, the memory 106 includes a non-transitory computer readable storage medium. Such a medium may take many forms, including but not limited to, non-volatile media, volatile media, and transmission media.

The electronic device 101 may further include a user input 128, a user output 124, a user interface 120, a communication interface 108. The communication interface 108 may include a GSM, CDMA, FDMA and/or analog cellular telephony transceiver capable of supporting voice, multimedia and/or data transfers over a cellular network. One or more components of the electronic device 101 may communicate with another utilizing a communications bus 140. Alternatively, or in addition, the communication interface 108 may include a Wi-Fi, BLUETOOTH™, WiMax, infrared, NFC or other wireless communications link. The communication interface 108 may be associated with one or more shared or dedicated antennas. The type of medium used by the electronic device 101 to communicate with other electronic devices and/or network equipment may depend upon the communication applications availability on the electronic device 101.

The electronic device 101 may include a user interface 120 allowing a user (not shown) to interact with the electronic device 101. For example, the user may be able to utilize a keyboard, mouse, stylus, touchscreen, and/or other means, to select an icon and/or cause the icon to become selected, where the icon is displayed according to the configuration of the user interface. Additionally, the user may be able to use a stylus to invoke an action consistent with a user input 128, for example. Examples of user input devices 128 include a keyboard, a numeric keypad, a touchscreen, a microphone, scanner, a stylus, and a pointing device combined with a screen or other position encoder. Examples of user output devices 124 include a display, a touchscreen display 108, a speaker, and a printer.

The input detector 132 may include one or more sensors that detect and/or measure contact between a user and the touchscreen 108. For example, the contact detector 132 may communicate with the touchscreen 108 and receive contact information including one or more locations of the contact. The input detector 132 may employ one or more algorithms to determine a response associated with the input; for example, whether a response is to be activated or invoked and communicate such indication to one or more components of the electronic device 101, for example, the processor/controller 112.

FIG. 2 is a block diagram illustrating a second system in accordance with at least some embodiments of the present disclosure. FIG. 2 depicts illustrative displays 202A-202D according to some configurations. Each display is shown as having a grid of cells (various cells of 204a-204s) in two dimensions, namely X and Y. Although the grids 202A-202D are shown as having various numbers of cells 204a-204s of rectangular shapes, any shape and configuration of grids and cells may be used in the embodiments described herein. The grids 202A-202D may each occupy an area that is an entire display area of a device, or the grids 202A-202D may each occupy only some of the display area. Also, the grids may alternate between occupying different amounts of the display area. The display of the grids and/or cells may be configurable settings. In addition, the display of the grids and/or cells may be determined automatically (e.g., based on an amount or type of information to display within a grid, within each cell, within a number of cells, etc.).

Each cell 204a-204s may be identified by having information and/or one or more identifiers of information associated with the cell. The information, identifiers, and/or display of the information and/or identifiers can take any form and may be a configurable setting. The information associated with each of the cells 204a-204s can be any type of information that a user may wish to access. For example, a first grid 202A, may have one or more first cells (e.g., 204a-204c) where each cell corresponds to a certain type of information. In various embodiments, the first grid 202A may correspond to a top level of, or root node of, a directory of information. The top level of information can be one or more folders that includes sets of other folders and/or files, one or more application programs (e.g., a spreadsheet, an email application, a document, etc.), one or more menus of information, and the like.

A user may navigate between cells 204a-204c of the first grid 202A, as well as select any one of the cells 204a-204c, in any manner. For example, a user may use a predetermined input, such as a combination of keys on a keyboard (including arrow keys, number keys, a number pad, or other adjacent combinations of keys) to navigate between the cells of grid. The predetermined input may be configured and changed at any time and in any manner. An input may also be a softkey input that is flexibly programmed to be associated with a certain function (e.g., causing the electronic device 101 to display a grid containing a specified set of information associated with one or more cells of the grid). In some embodiments, the softkey input may be an icon that is displayed on a touch-sensitive display surface of the electronic device 101. Any other types of input devices may be used to navigate the grids and cells, including and not limited to a mouse, a trackpad, touch input, and voice input. In various embodiments, an input can include pressing a specified combination of keys on a keyboard. This may be a first input that causes a first grid to be displayed corresponding to the combination of keys being pressed. In various embodiments, the second input includes releasing a first key from the combination of keys, which causes the system to navigate to one of a number of cells in the first grid. In other embodiments, an initial combination of keys is pressed and released to display a corresponding grid with cells containing information. In some embodiments, different combinations of keys on a keyboard are associated with different sets of information associated with each of the first number of cells in the first grid, and the first input includes pressing one of the different combinations of keys.

The type of input can be configurable, and a user may switch between multiple methods of providing input. In some embodiments, a processor may automatically detect that one method of input has stopped working or that another method would be preferable, and the system may switch to another method of input. The methods of input may be configured automatically by the system (e.g., to automatically implement preferred methods of input) or they may be configured by one or more users or administrators.

Selecting a cell within a first grid (e.g., grid 202A) causes one or more additional cells of a subsequent grid to be displayed. The subsequent cells contain additional information that may be a sub-type of information of the selected cell. Referring to grid 202A, a user may select cell 202a and upon selection of cell 202a, grid 202B showing cells 204r-204s may be displayed. The information associated with each of the cells 204r-204s may be a sub-type of information related to the information associated with cell 204a. Thus, by way of example, if cell 204a contained a menu item, cells 204r and 204s can contain menu items that are sub-menu items of the menu item of cell 204a. As another illustrative example, if cells 204a-204c are each associated with locations within a document (e.g., each cell is a page number, or each cell is a section of the document), then cells 204r and 204s can contain information within the portion of the document that was associated with cell 204a (e.g., paragraphs within the section of cell 204a or paragraphs on the page corresponding to cell 204a, etc.). Then, when cell 204a is selected (e.g. a particular page or section of the document is selected), the display may then show the grid of the sub-type of content within that selection (e.g., paragraphs within the page or section). Continuing with the example as it relates to grid 202B, there may be two paragraphs, with each paragraph (or an indicator thereof) displayed within a respective cell 204r and 204s.

Grids 202C and 202D may also contain information related to cells selected by a user. For example, if cell 204s is selected, this may invoke grid 202C to appear on the display. The information associated with each of the cells 204d-204i may be a sub-type of information related to the information associated with cell 204s. Said another way, cells 204d-204i can contain information that is a subset of information from cell 204s. Thus, in some embodiments, if cell 204s contained a sub-menu item, cells 204d-204i can contain menu items that are further sub-menu items of the sub-menu item of cell 204s. As another example, if cells 204r and 204s are each associated with locations within a document (e.g., each cell is a paragraph, as discussed above) and cell 204s is selected, then cells 204d-204i can contain information within the paragraph that was associated with cell 204s (e.g., each of the sentences within paragraph of cell 204s may be associated with each of cells 205d-204i). Then, when cell 204s is selected (e.g. a particular paragraph of the selected section of the document is selected), the display may show the grid of content within that selection (e.g., sentences within the paragraph). Continuing with the example, there may be six sentences, with each sentence (or an indicator thereof) displayed within a respective cell 204d-204i.

As discussed herein, the display of the grids and cells may be automatically configured so that the number of cells displayed is based on a type of, or an amount of, content to display. Thus, if there are two paragraphs, then two cells may be displayed with each cell corresponding to one paragraph. If there are six sentences to display, then six cells may be displayed with each cell corresponding to one sentence. In addition, if there are five sentences to display, then six cells may be displayed with five of the cells each corresponding to one sentence, or additional numbers of cells may be displayed where only five of the cells each correspond to a sentence.

In some embodiments, one or more of the grids, or a portion of the display, may contain “empty” space, or one or more “empty” cells. For example, if the information within a grid of 2×3 cells corresponds to five pieces of information, then only five of the six cells may have information associated with them, with the sixth cell being “empty.” The systems and methods disclose herein may also hide “empty” space or cells in certain situations. Thus, an “empty” cell may act as a placeholder or a visual indicator of missing (in some embodiments, to be completed) information, which may be hidden from view if desired by the user. This may be a configurable setting.

In some embodiments, the content may be edited using the grids and cells. Thus, for example, if a user desires to add sentences then the user may select an “empty” or extra cell (e.g., an empty sixth cell if there are currently only five sentences in the selected portion of the document) to edit the text (e.g., add a sentence) to the sixth cell. The user may further edit the cells, such as moving the cell to a desired location as it relates to the other content (e.g., cells). By way of example, in grid 202C, a user may move cell 204f so that it is located between cells 204d and 204e. When a user edits content (or portions of content) of the cell or a location of a cell or content of a cell, this could be configured to likewise move the content within the source of the information. Thus, using FIG. 2 as an example, if there are six sentences within a specified portion of a document, and each of the sentences (or an indicator thereof) is displayed within a respective cell 204d-204i, the content (e.g., the sentences) can be moved or otherwise edited within the document by editing the content of the cells within the grid. If a fifth sentence is located in cell 204h and is in between a fourth sentence in cell 204g and a sixth sentence in cell 204i, and cell 204h is moved within the grid to be located between cell 204d (containing a first sentence) and cell 204e (containing a second sentence), then the fifth sentence is moved in the document itself to be between the first sentence and the second sentence. Users may therefore edit the grids cells and content within the grids and cells.

In grid 202C, if cell 204h is selected, grid 202D may appear on the display. The information associated with each of the cells 204j-204q may be a sub-type of information related to the information associated with cell 204h. Cells 204j-204q contain information that is a subset of information from cell 204h. Thus, in some embodiments, if cell 204h contained a sub-menu item, cells 204j-204q can contain menu items that are further sub-menu items of the sub-menu item of cell 204h. As another example, if cells 204d-204i are each associated with sentences within a particular paragraph of a document (e.g., each cell is a sentence, as discussed above), then cells 204j-204q can contain information associated with the sentence of the selected cell 204h. For example, one or more of the cells 204j-204q may contain a word within the sentence of the selected cell 204h. As another example, if the sentence of cell 204h has a bulleted list associated with the sentence, each of cells 204j-204q may contain an item on the bulleted list (e.g., each item on the bulleted list may be associated with each of cells 205j-204q). Then, when cell 204h is selected (e.g. a sentence is selected), the display may show the grid of content within that selection (e.g., items on the bulleted list that are associated with the sentence of cell 204h). Continuing with the example, there may be eight items on the bulleted list, with each item on the list (or an indicator thereof) displayed within a respective cell 204j-204q.

Thus, in embodiments of the present disclosure, in response to an input from a user, a grid is displayed containing one or more cells. Different grids, and different content of the grids, may be displayed depending on what input is received from the user. For example, different key combinations input by the user may cause different grids (e.g., having different visual appearances, or cells having different content within the grid, or different numbers of cells within the grid) to be displayed. Further, different inputs may cause different actions to be taken by the system with respect to the display, the grid(s), and/or cells within a grid. In some embodiments, a minimum cell or grid size can be imposed, or a minimum size of the information within a cell may be imposed.

In grids disclosed herein, it is not necessary for all cells within a grid to contain a same type of information. For example, some cells may contain all information within the cell (e.g., a single word) while other cells may contain an indicator of the information associated with the cell (e.g., an indicator that the cell relates to a third paragraph on a page). Further, a cell may have no associated information and/or identifier and may be “empty” or blank. In addition, the first grid 202A may contain various combinations of programs or information associated with the cells 204a-204c, and the combinations of programs or information can be related or unrelated. For example, a combination of three different programs may be associated with each of the cells 204a-204c, such as three of the most commonly used programs for a user (e.g., an email program, a web browser, and a word processing program). In other embodiments, three directory locations may be associated with each of the cells 204a-204c, such as three directory locations that are frequently visited by a user. Some grids of cells may contain combinations of access to apparently unrelated information (e.g., application programs and directories of information not related to the application programs) because a user may configure a grid to have any type of information associated with the cells. Thus, any combination of information or types of information (e.g., application programs and sub-types of information) may be associated with each of the cells 204a-204c.

A user may navigate linearly from one grid to another by selecting a cell to view a set of related information (e.g., another grid containing a sub-type of information), or a user may navigate between grids by providing input that allows the user to jump to a particular grid or type of information, without selecting various cells to obtain the desired grid or type of information. Using one of the examples discussed in relation to FIG. 2, a user may provide an input that causes grid 202D to be displayed, without having first selected any cells from grids 202A, 202B, or 202C. Although only four grids are shown in FIG. 2, any number and configuration of grids may be used with the methods and systems described herein.

The grids may occupy any portion of a display area. In some embodiments, the grids may occupy an entire display area. Thus, if a display area is a height Y by a width X, then grid 202A may have a height Y1 that equals Y and a width X1+X2+X3 that equals X. Also, grid 202B may have a height Y6 that equals Y and a width X8+X9 that equals X; grid 202C may have a height Y2+Y3 that equals Y and a width X1+X2+X3 that equals X; and grid 202D may have a height Y4+Y5 that equals Y and a width X4+X5+X6+X7 that equals X. Alternatively, any of the heights and/or widths of any of the grids may be less than X and/or Y. Further, the heights and widths are customizable and can be based on any factors. In various embodiments, the heights and widths may be determined automatically based on the content associated with the cells displayed, based on a number of cells that are displayed, etc.

In addition, the sets of spatial (X, Y) coordinates may relate to indicators associated with each cell, such as acoustic parameters, that be used to signify location to a visually impaired user in order to aid in navigation. The differences in sound may be used to navigate the cells in a grid and perform actions on grids and cells, as well as to perform gestures on a touch-sensitive device or mouse and track pad gestures (e.g., flick, tap, or freehand gestures) to navigate the grids as described herein.

As shown by the discussion of FIG. 2 above, and the remaining discussion herein, the illustrative methods and systems described herein advantageously improve user interfaces to make various content more manageable and accessible. Users often interact with content areas that are time consuming to navigate, and the present embodiments can improve the speed and accessibility of navigation by providing a concise organization of the content. Further, the methods and systems disclosed herein can advantageously provide intuitive structures for navigating large and complex content. Embodiments of the user interfaces disclosed herein provide improved tools and greatly increase and improve the ability of users to access content, and also edit content by facilitating navigation of such content and by making the content more easily and quickly accessible, and thus usable. The example user interfaces disclosed herein enable a user to access structured content that progresses from a higher, top-view, node to lower nodes (e.g., nodes having information that is a sub-type of information to the respective higher node).

As can be seen by the examples provided above, the methods and systems described herein can be used on various devices, including and not limited to a touch sensitive mobile device, such as a mobile phone, tablet computer, or the like, as well as non-touch sensitive devices, such as laptop computers, desktop computers, and the like. For example, the grids together with various input methods are compatible with a laptop or desktop computer to provide customizable uses of input devices (e.g., customizable uses of a keyboard by configuring certain keys to be used to invoke and navigate the grids). For example, using various input devices, users may move among different applications and information within the applications.

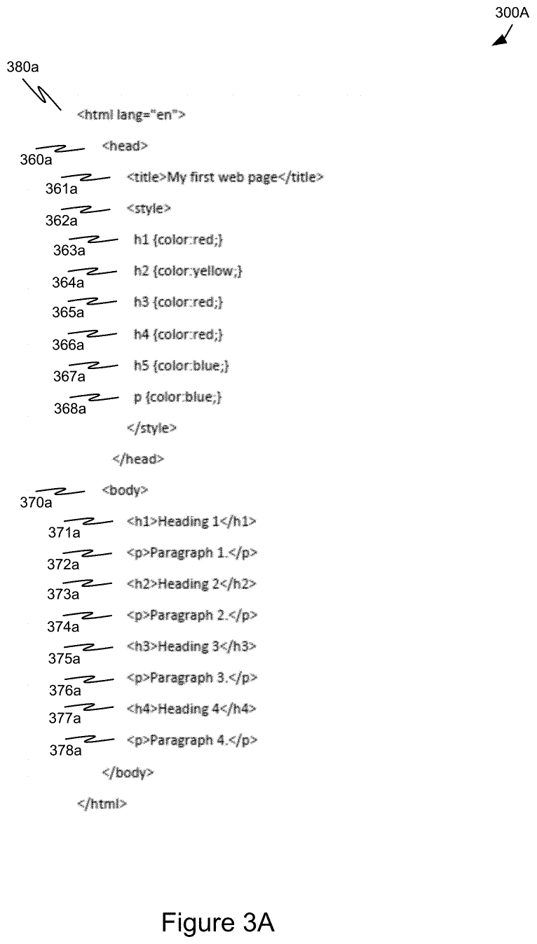

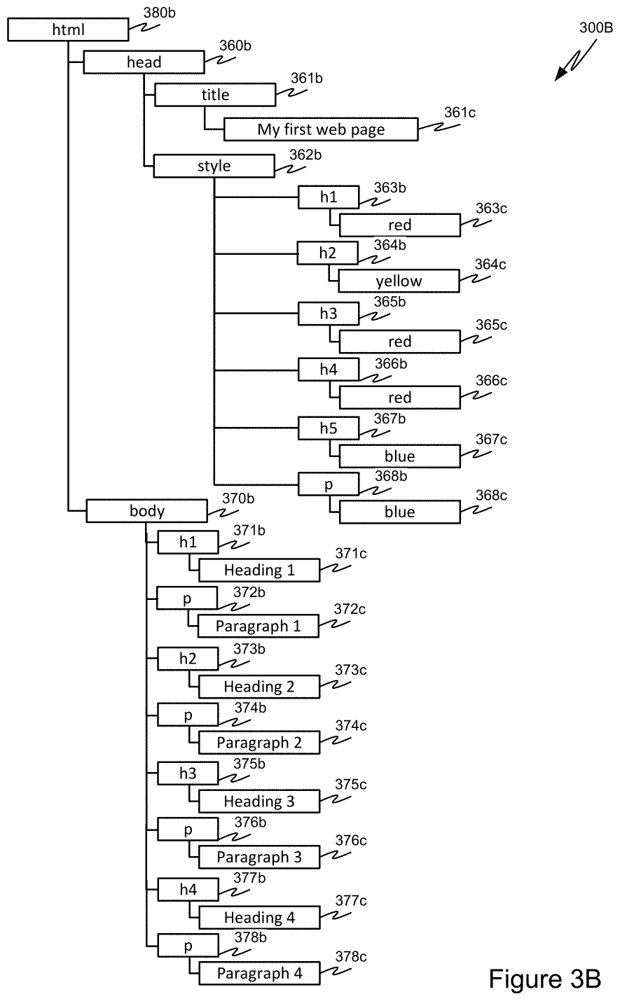

FIG. 3A is a representation of a HTML document 300A in accordance with at least some embodiments of the present disclosure. FIG. 3B is a block diagram illustrating a Document Object Model (“DOM”) 300B corresponding to the HTML document 300A of FIG. 3A in accordance with at least some embodiments of the present disclosure. The methods and systems disclosed herein may be used to navigate the content of the HTML document 300A and the DOM 300B.

More specifically, to select the HTML document, a user may provide an initial input, which may be any input as described herein. Upon receiving the input, a display may present a grid with different information presented in each cell, where one of the cells includes information corresponding to the HTML document. In some embodiments, the information of the cell can be an identifier of the HTML document. The user may then select the cell indicating that it will provide the relevant HTML document information in order to access additional content of the HTML document.

Alternatively, the user may be able to directly access the content of the HTML document via the input. If the user directly accesses the HTML document without having to make another selection (e.g., without having to select a cell to access the HTML document content), a grid displaying an upper level content of the HTML document may be displayed. In various embodiments, the initial grid is a 1×3 arrangement of cells, as in grid 202A. The grid displaying the information corresponding to the HTML document may initially display upper levels, or upper nodes, of the HTML document. Continuing with relating the elements of FIG. 3A to FIG. 2, the header (e.g., element <head> 360a in FIG. 3A) is displayed in a first cell 204a and the body (e.g., <body> 370a in FIG. 3A) is displayed in a second cell 204b. Cell 204c is “empty” and does not have any information displayed that corresponds to that cell. Although the initial grid is shown as having a 1×3 cell layout with two cells occupied, other configurations may be used. For example, two cells may display <head> 360a and <body> 370a, respectively. Alternatively, four or more cells may be displayed with multiple cells being “empty,” associated with no information, and/or acting as placeholders.

In various embodiments, indicators of associated information (e.g., an indicator that cell 204a relates to the header element and an indication that cell 204b relates to the body element) may be displayed instead of the content itself. Any type of visual and/or audible indicator may be used to indicate the information that corresponds with each cell. For example, a “h” may be displayed to indicate the cell corresponds to the header, and a “b” can be displayed to indicate that the cell corresponds to the body. Any amount of information may be displayed within a single cell. In some embodiments, an upper level of information may be displayed in a single cell (e.g., that the cell corresponds to a title) while a sub-type of the information may be displayed in a subsequently-selected cell (e.g., a content of the title). In other embodiments, multiple pieces of information may be associated with a single cell; for example, a single cell may contain an indicator that the cell relates to a title and also the content of the title, so that upon selection of the cell the user may view or edit the content of the title without selecting a subsequent cell. A user may take any action on the information by selecting the cell. For example, a user may view the information. The user may also edit the information contained within the cell. In addition, a user may select multiple cells to perform an action on multiple cells at a same time.

When cell 204a, corresponding to <head> 360a, is selected by a user, the display updates to show a grid of a sub-type of information associated with <head>, specifically, grid 202B is displayed, having cells 204r and 204s. Cell 204r displays information corresponding to <title> My first web page </title> 361a. As explained above, in some embodiments, cell 204r may display <title> (or an indication thereof) and the actual content of the title (e.g., My first web page) may be displayed in a subsequent cell that is accessed by the user by selecting the cell displaying <title>. In other embodiments, cell 204r may display <title> My first web page (or indicators thereof) all together within the cell 204r. The choice to display an entirety of an amount of information, or only indicators of an amount of information, may be made automatically at the system level and is configurable by users or administrators. Similarly, for other cell content described herein, information may be displayed on a very granular level per cell (e.g., only <title> in one cell, and the content of the title in a subsequent cell), or various types of information may be displayed together in a single cell (e.g., one cell may contain <title> My first web page </title>).

Cell 204s can contain information associated with <style> 362a. When a user selects cell 204s, information that is a sub-type of information to <style> is displayed in a grid. For example, grid 202C is displayed with six cells, and each cell contains information of, or information indicating or corresponding to, each of the items in the sub-type of information of <style> 362a. Thus, cell 204d can contain h1 {color:red;} 363a, cell 204e can contain h2 {color:yellow;} 364a, cell 204f can contain h3 {color:red;} 365a, cell 204g can contain h4 {color:red;} 366a, cell 204h can contain h5 {color:blue;} 367a, and cell 204i can contain p {color:blue;} 368a.

A user may navigate through the HTML document in any manner. Users may go up and down through levels of the grids to navigate to different positions (or levels) within the HTML document. A user may use any type of input to navigate, and may have shortcuts to jump to a certain level within information, to a certain set of information within information, to a specific grid or set of cells, to a specific type or sub-type of information, etc. As discussed herein, users may select one or more cells to perform different actions, such as editing the content of the cells. Users may also configure the grids to appear as desired, including changing the visual appearances of the grids and/or cells and changing audio indicators associated with the grids and/or cells. Thus, a user may navigate from grid 202C back to grid 202A and then select cell 204b to view the sub-type of information that is under the <body> 370a of the HTML document.

Upon selecting cell 204b, grid 202D may appear, showing all of the information that is one level below the <body> 370a of the HTML document. For example, cell 204j can contain <h1>Heading 1</h1> 371a, cell 204k can contain <p>Paragraph 1.</p> 372a, cell 204l can contain <h2>Heading 2</h2> 373a, cell 204m can contain <p>Paragraph 2.</p> 374a, cell 204n can contain <h3>Heading 3</h3> 375a, cell 204o can contain <p>Paragraph 3.</p> 376a, cell 204p can contain <h4>Heading 4</h4> 377a, and cell 204q can contain <p>Paragraph 4.</p> 378a.

FIG. 3B represents a DOM of the HTML document of FIG. 3A, and a user may similarly employ the methods and systems herein to navigate the elements of FIG. 3B. Elements of the DOM can be described in relation to a hierarchical tree, with the various elements of the DOM each corresponding to a node of the tree. Different levels of nodes in the tree correspond to levels of elements in the HTML document.

To select the DOM using the methods and systems disclosed herein, a user may provide an initial input, which may be any input as described herein. Upon receiving the input, the user may see a grid with different information presented in each cell, where one of the cells includes information corresponding to the DOM. The user may then select the cell associated with the DOM to access additional content of the DOM. Alternatively, the user may be able to directly access the DOM via a user input. If the user directly accesses the DOM, a grid displaying an upper level content of the DOM may be displayed for the user to begin navigation. In various embodiments, the initial grid is a 1×3 arrangement of cells, as in grid 202A. The grid displaying the information corresponding to the DOM may initially display upper levels, or upper nodes, of the DOM.

The DOM starts with a root node of html 380b of FIG. 3B, and in this embodiment, a user has provided input to display grid 202A. The upper level content of the DOM (e.g., a same level of nodes in an upper level of the tree) may be displayed. Thus, the header (e.g., element head 360b in FIG. 3B) is displayed in a first cell 204a and the body (e.g., element 370b in FIG. 3B) is displayed in a second cell 204b. Cell 204c is “empty” and does not have any information displayed that corresponds to that cell. When cell 204a, corresponding to head 360b, is selected by a user, the display updates to show a grid of a sub-type of information of head 360b. Specifically, grid 202B is displayed with cells 204r and 204s. As discussed herein, as a user navigates through the grids, same levels of information (e.g., a same level of nodes in a tree) of the DOM may be displayed at a same time in order to allow a user to quickly and efficiently navigate through content. Cell 204r displays information for the title, which corresponds to title 361b. In some embodiments, cell 204r can display information of both the title 361b and the content of the title “My first web page” 361c, or in other embodiments, cell 204r can display only title 361b, and a user would select cell 204r to view/access the content “My first web page” 361c in a subsequent cell (not shown). Cell 204s displays information indicating that it is associated with style 362b.

A user may select cell style 362b to access the sub-types of information (e.g., information in a next level down from style 362b) in a subsequent grid. In particular, grid 202C may be displayed when a user selects style 362b, and cell 204d can contain h1 363b, cell 204e can contain h2 364b, cell 204f can contain h3 365b, cell 204g can contain h4 366b, cell 204h can contain h5 367b, and cell 204i can contain p 368b. In some embodiments, each of these individual cells can contain the additional content associated with h1 363b-p 368b (e.g., the additional content colors 363c-368c), or in other embodiments, a user may view/access the additional content of each of h1-h5 and p by selecting the individual cell 204j-104p associated with each of h1-h5 and p in order to obtain the additional content in a subsequent cell (not shown).

A user may also navigate to cell 204b to select this cell and the content of body 370b. If the user selects cell 204b, a grid 202D displaying content of a sub-type of information of body 370b is displayed. In grid 202D, cell 204j can contain h1 371b, cell 204k can contain p 372b, cell 204l can contain h2 373b, cell 204m can contain p 374b, cell 204n can contain h3 375b, cell 204o can contain p 376b, cell 204p can contain h4 377b, and cell 204q can contain p 378b. In some embodiments, each of these individual cells can contain the respective additional content associated with h1 371b-p 378b (e.g., additional content Heading 1 371c-Paragraph 4 378c), or in other embodiments, a user may view/access the additional content of each of h1 371b-p 378b by selecting the cell 204j-104p associated with each of h1 371b-p 378b to obtain the additional content (e.g., Heading 1 371c-Paragraph 4 378c) in a subsequent cell (not shown).

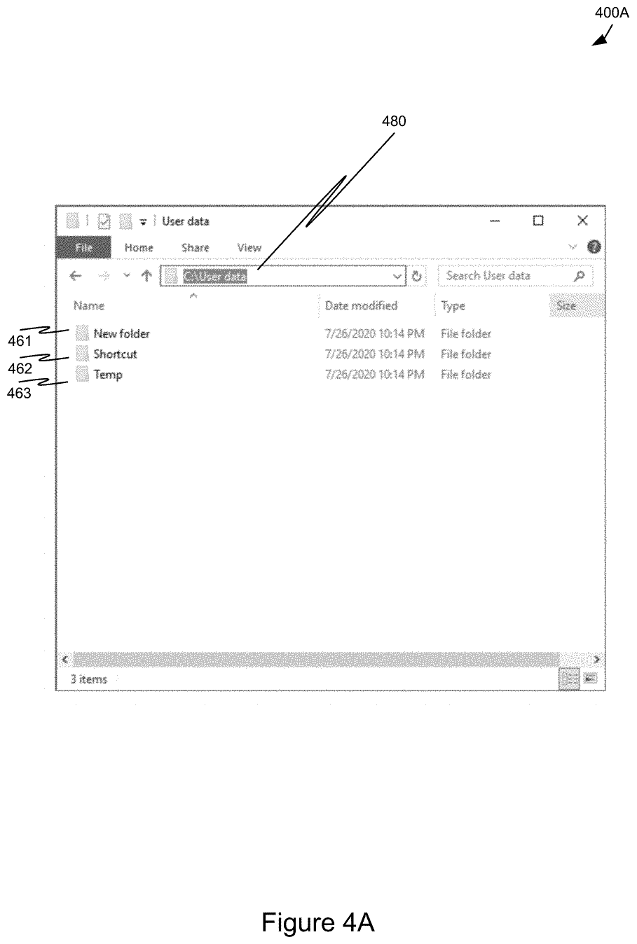

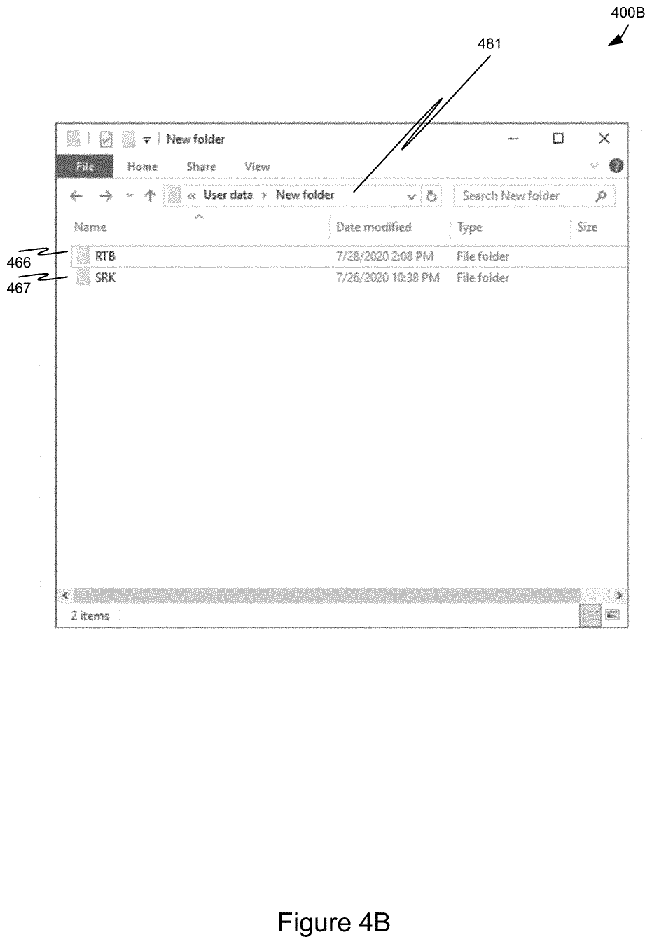

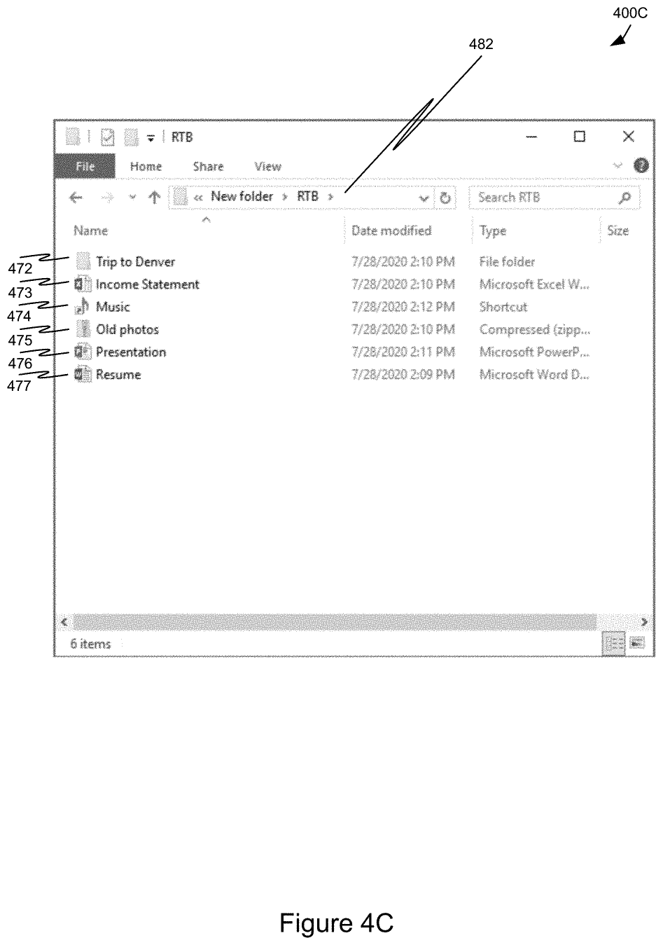

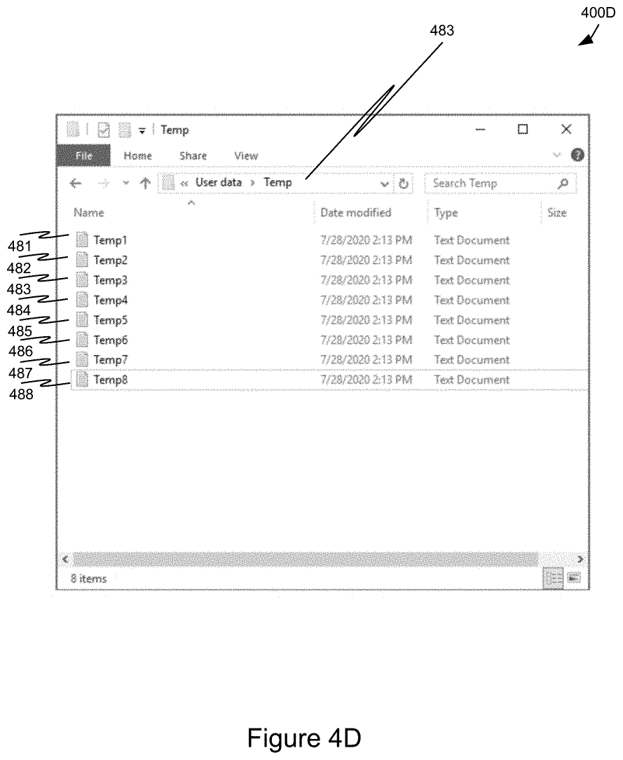

FIG. 4A is a screenshot 400A depicting a first set of information in accordance with at least some embodiments of the present disclosure. In FIG. 4A, a folder is displayed to navigate a directory of content on a device. The grid associated with the content of the folder at location C:\User data may be opened by a user providing a specified input. For example, a user may select a specific combination of keys on a keypad to open a grid associated with the content of the folder at this location on the C: drive. If a user desires to navigate to a different location, a user may enter a different input, such as a different combination of keys on a keypad. In FIG. 4A, there are three items of content shown, which are folders New folder 461, Shortcut 462, and Temp 463. When a user provides an input to display a grid associated with the location C:\User data, grid 202A may be displayed showing cell 204a containing an indicator that it relates to New folder 461, cell 204b containing an indicator that it relates to Shortcut 462, and cell 204c containing an indicator that it relates to Temp 463.

If a user selects cell 204a for New folder 461, then grid 202B is displayed, which corresponds to information within New folder 461 (e.g., a sub-type of information of New folder 461), as shown in FIG. 4B. FIG. 4B is a screenshot 400B depicting a second set of information in accordance with at least some embodiments of the present disclosure. Grid 202B contains cell 204r having information associated with folder RTB 466 and cell 204s having information associated with folder SRK 467. As shown in FIG. 4B, the information associated with the cells of grid 202B corresponds to the folder location at C:\User data\New folder.

A user may select cell 204r to navigate to the content of folder RTB 466 in grid 202C, which corresponds to FIG. 4C. FIG. 4C is a screenshot 400C depicting a third set of information in accordance with at least some embodiments of the present disclosure. Grid 202C displays cell 204d containing folder Trip to Denver 472, cell 204e containing spreadsheet Income Statement 473, cell 204f containing a shortcut to music file Music 474, cell 204g containing zipped folder Old photos 475, cell 204h containing file Presentation 476, and cell 204i containing document Resume 477. As shown in FIG. 4C, the information associated with the cells of grid 202C corresponds to the folder location at C:\User data\New folder\RTB.

If a user navigates back up grids (e.g., up through levels of information), the user can navigate back to grid 202A, which displays cells 204a-204c, and the user may select another cell. For example, the user may select cell 204c containing an indicator that it relates to Temp 463. Upon selection of cell 204c, grid 202D is displayed, which corresponds to FIG. 4D. FIG. 4D is a screenshot 400D depicting a fourth set of information in accordance with at least some embodiments of the present disclosure. In grid 202D, cell 204j contains an indicator that it relates to folder Temp1 481, cell 204k contains an indicator that it relates to folder Temp2 482, cell 204l contains an indicator that it relates to folder Temp3 483, cell 204m contains an indicator that it relates to folder Temp4 484, cell 204n contains an indicator that it relates to folder Temp5 485, cell 204o contains an indicator that it relates to folder Temp6 486, cell 204p contains an indicator that it relates to folder Temp7 487, and cell 204q contains an indicator that it relates to folder Temp8 488. As shown in FIG. 4D, the information associated with the cells of grid 202D corresponds to the folder location at C:\User data\Temp 483. If a user would like to see any sub-types of information associated with Temp1 481-Temp8 488, the user may select the cell associated with the desired information.

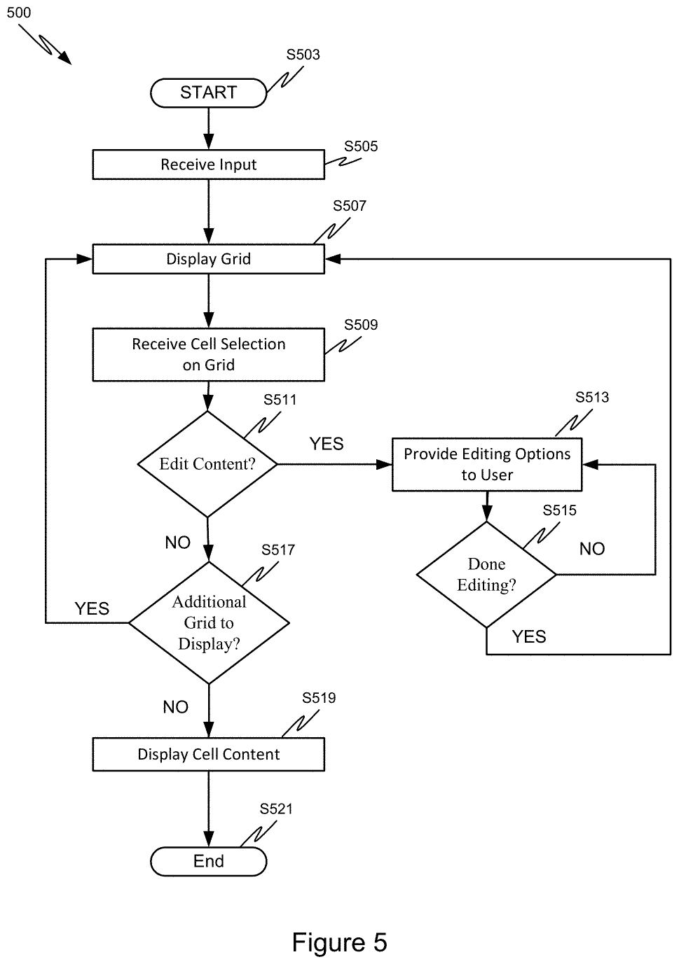

FIG. 5 is a flow diagram depicting a method 500 in accordance with at least some embodiments of the present disclosure. FIG. 5 starts at S503, then a user receives input at step S505. The input may be received from one or more input devices, and may be configurable. Based on the input selected, a grid is displayed to the user at step S507. The type of grid, configuration of the grid, and content of the grid may be determined by the input from the user, by settings configured by a user or an administrator, or by any other pre-defined settings. In various embodiments, the content of the grid is determined by the information the user is viewing, and a level of the information that the user is viewing. In some embodiments, the configuration of the grid is determined based on an amount of content to be displayed and an area of the display. For example, a grid may be pre-defined so that the root node of the information, or a level of information directly adjacent to the root node, displayed by the grid displays in a 3×3 number of cells. In some aspects, as discussed herein, an initial grid may display multiple types of information from which a user may select (e.g., the initial 3×3 set of cells may display multiple types of information (such as multiple types of programs, multiple types of documents, multiple type of locations, mixes of different types of information, etc.) at a root node of each type of information)

At step S509, the system receives a cell selection on the grid. A user may select a cell on the grid to display and access desired information. The cell selection may be received via any type of user input. The user input may be received from one or more input devices, and may be configurable. For example, a user may configure a keypad so that all of the arrow keys, enter key, and keys of a numerical keypad may be used to select a cell. The user may also configure the input so that if a mouse is used, then a point and left-click may be used to select a cell and a scroll function of a mouse may be used to navigate through the cells or select multiple cells.

At step S511 the system determines whether a user would like to edit the information associated with the cell. The system may receive an input from the user that indicates that they would like to edit the cell (e.g., at step S509, when a user selects a cell on the grid, the system may then provide an inquiry to the user to query whether the user would like to edit the information associated with the cell). Alternatively, the user may provide an additional input indicating that they would like to edit the information associated with the cell, such as selecting to edit the information after selecting the cell. If the user would like to edit the content, then the system may provide editing options to the user at step S513. The editing options may include any type of editing options, such as adding or deleting the content or portions of the content. The user may also edit properties of the cell itself, such as a position of the cell within the grid, or moving content, or portions of content, to a different cell or grid. As the user edits the content, the system determines, or the user may specify, whether the editing is completed at step S515. If the user is not done editing, then the process proceeds back to step S513, where the user may select editing options. If the user is done editing the content, then the system proceeds to step S507, where the grid is displayed. The grid being displayed now contains the edited information (or indicator(s) thereof) for the cell that was edited at step S513.

If the user does not want to edit the content in step S511, then the system proceeds to step S517. At step S517, the system determines whether an additional grid is to be displayed. This may be determined based on the cell selection made in step S509 and the related information. If there is no additional grid to display, then the system displays the cell content of the selected cell in step S519. If there is an additional grid to display, then the system returns to step S507 to display an additional grid. For example, if the cell content of the selected cell in step S509 has lower level content or a sub-type of information, then an additional grid may be displayed that contains cells where individual cells contain the information in the lower level content or sub-type of information. In some embodiments, if the cell content of the selected cell in step S509 has related content, then an additional grid may be displayed that contains cells where individual cells contain the related content.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of navigating information, the method comprising:
detecting, at an electronic device, a first input;
displaying, in response to the first input, a first number of cells in a first grid;
receiving, as a second input at the electronic device, a first selection of a first cell in the first number of cells in the first grid, wherein the first cell comprises a first piece of information; and
displaying, in response to the receiving the first selection, a second number of cells in a second grid,
wherein cells in the second number of cells corresponds to a sub-type of information related to the first piece of information, and
wherein the first input comprises pressing a specified combination of keys at a same time on a keyboard.

2. The method of claim 1, further comprising:
receiving, as a third input at the electronic device, a second selection of a second cell in the second number of cells, wherein the second cell comprises a second piece of information; and
in response to the receiving the second selection, displaying a third number of cells in a third grid, wherein cells in the third number of cells each corresponds to a sub-type of information related to the second piece of information.

3. The method of claim 1, further comprising:
receiving, as a third input at the electronic device, a second selection of a second cell of the first number of cells in the first grid, wherein the second cell comprises a different piece of information; and
in response to the receiving the second selection, displaying a third number of cells in a third grid, wherein each of the cells in the third number of cells corresponds to a sub-type of information related to the different piece of information.

4. The method of claim 1, further comprising:
a set of grids comprising the first grid and the second grid, wherein the second number of cells displayed in the second grid shows only nodes at a single level of the tree structure of elements, wherein the first grid is not displayed when the second grid is displayed;
receiving, as a third input at the electronic device, at least one additional selection of a second cell in one grid in the set of grids; and
in response to the receiving each additional selection, displaying a corresponding number of cells in a corresponding grid, wherein when the corresponding number of cells is displayed, a cell corresponding to the at least one additional selection is not displayed;
wherein cells in the corresponding number of cells in each of the corresponding grids are each determined based on a number of nodes in a level of a tree structure of elements, and
wherein information in at least some of the corresponding number of cells in each of the corresponding grids corresponds to nodes in the tree structure of elements.

5. The method of claim 1, wherein the first number of cells is a preset number of cells, and wherein the preset number of cells is based on a screen size of the electronic device.

6. The method of claim 1, wherein the first number of cells is determined based on a number of nodes in a level of a tree structure of elements, and wherein the first number of cells is greater than the number of nodes.

7. The method of claim 6, wherein the tree structure of elements is a web page Document Object Model (“DOM”).

8. The method of claim 1, wherein the second input comprises pressing or releasing a first key.

9. The method of claim 1, wherein an outer circumference of each cell in the first number of cells is visible.

10. The method of claim 8, wherein pressing or releasing a subsequent key navigates to one of the second number of cells in the second grid.

11. The method of claim 1, wherein different combinations of keys on a keyboard are associated with different sets of information associated with each of the first number of cells in the first grid, and wherein the different combinations of keys comprises the specified combinations of keys.

12. The method of claim 1, wherein the first grid occupies a first area of a display screen, wherein the second grid occupies an entirety of the first area, and wherein a size of the second grid does not depend on a number of items shown in the second grid.

13. The method of claim 1, wherein the first grid is a layout of 3x3 cells.

14. The method of claim 1, wherein the first grid and the second grid are navigated by either one of a keyboard and a mouse, and wherein if the either one of the keyboard and the mouse stop working then the other one of the keyboard and the mouse navigates the first grid and the second grid.

15. A system of navigating information, comprising:
a processor; and
computer memory storing data thereon that enables the processor to:
detect, at an electronic device, a first input;
display, in response to the first input, a first number of cells in a first grid;
receive, as a second input at the electronic device, a first selection of a first cell in the first number of cells in the first grid, wherein the first cell comprises a first piece of information; and
display, in response to the receiving the first selection, a second number of cells in a second grid,
wherein each of the cells in the second number of cells corresponds to a sub-type of information related to the first piece of information, and
wherein the first input comprises pressing a specified combination of keys at a same time on a keyboard.

16. The system of claim 15, wherein the first grid corresponds to a first level of nodes in a tree structure, and wherein the second grid corresponds to a second level of nodes in a tree structure that is a sub-level of one of the nodes in the first level.

17. The system of claim 15, wherein the first number of cells is a preset number of cells, and wherein the preset number of cells is determined based on a number of nodes in a level of a tree structure of elements.

18. The system of claim 15, wherein different combinations of keys on a keyboard, when each of the combinations of keys is pressed at a same time, are associated with different sets of information associated with each of the first number of cells in the first grid, and wherein the different combinations of keys comprises the specified combination of keys.

19. The system of claim 15, wherein the first number of cells in the first grid are not displayed when the second number of cells in the second grid is displayed.

20. A system, comprising:
a microprocessor and a computer-readable medium coupled thereto, wherein the microprocessor receives and executes instructions from the computer-readable medium and wherein the instructions cause the microprocessor to:
detect, at an electronic device, a first input;
display, in response to the first input, a first number of cells in a first grid;
receive, as a second input at the electronic device, a first selection of a first cell in the first number of cells in the first grid, wherein the first cell comprises a first piece of information; and
display, in response to the receiving the first selection, a second number of cells in a second grid,
wherein cells in the second number of cells corresponds to a sub-type of information related to the first piece of information, and
wherein the first input comprises pressing a specified combination of keys at a same time on a keyboard.
